(19) United States
(12) Patent Application Publication
(10) Pub. No.: US 2003/0169700 A1
(43) Pub. Date: Sep. 11, 2003

(54) Power margin control

(76) Inventor: Bjorn Nilsson, Jarlasa (SE)

Correspondence Address: YOUNG & THOMPSON, 745 SOUTH 23RD STREET 2ND FLOOR, ARLINGTON, VA, 22202

(21) Appl. No.: 10/363,224

(22) PCT Filed: Sep. 6, 2001
(86) PCT No.: PCT/SE01/01903

(30) Foreign Application Priority Data
Sep. 8, 2000 (SE) 00032029
Nov. 3, 2000 (US) 60246433

(51) Int. Cl. H04B 7/185

(52) U.S. Cl. 370/318; 370/338

(57) ABSTRACT

A method of testing signal power margin in a wireless local area network (LAN). A peripheral unit is capable of responding to a message from said transceiver unit (TRX) by sending an acknowledgement signal (ACK) back to said transceiver unit (TRX). A situation in the network where the acknowledgement signal (ACK) power is reduced is simulated. Then, a message to said peripheral (ESL) is sent from said transceiver (TRX). It is registered whether or not an acknowledgement (ACK) from said peripheral (ESL) is received by the transceiver unit (TRX). A signal power margin test system for a local area network (LAN). A peripheral unit is capable of responding to a message from a transceiver unit (TRX) by sending an acknowledgement signal (ACK) back to said transceiver unit (TRX). The system comprises a control unit programmable to switch the relative signal power levels between a nominal power situation, and a simulated situation that corresponds to a system where the power margin is reduced.

### FIELD OF THE INVENTION

This invention relates generally to wireless communication systems, and more specifically to wireless Local Area Networks (LAN) and peripherals used for Electronic Shelf Labelling (ESL) in retail environments, and to devices and methods for checking signal power margins is such systems.

### DESCRIPTION OF RELATED ART

Wireless systems, for example, systems for electronic pricing are rapidly gaining popularity. Several hundred supermarkets are using such systems today. These systems all have a wireless communication network, which consists of a wireless infrastructure and peripherals (e.g. Electronic Shelf Labels, ESLs) connected to the infrastructure. Often several tens of thousands of wireless peripherals (e.g. ESLs) are used in these systems and this puts extreme requirements on connectivity. The extreme cost-pressure on such systems, and also the power and size constraints on the peripherals, set high requirements for power-efficient installations. It is equally important not to overinstall (e.g. have transmitters that are too powerful and therefore result in an increased initial cost) the systems in order to secure a good communication-coverage, as it is to avoid under-dimensioning the infrastructure (e.g. have transmitters which are too weak, which results in a signal-strength which does not reliably reach all the devices which the transmitter is intended to communicate with), which leads to malfunctions and increased maintenance costs. Tailoring or adjustments to peripherals or the communication infrastructure after a system has been placed in operation to correct malfunctions due to low signal-strengths is undesirable. This is due to cost and up-time reasons because if part of this system is down then some peripherals could, for example, have uncorrected, out-of-date pricing for certain items, which naturally is unacceptable. Re-structuring of the environment where the system is installed, for example a retail store, due to seasonal-campaigns or other reasons can also stress the conditions for establishing a wireless link between the communication infrastructure and the peripherals.

There are a few different ways known today for testing the power-levels in such systems. The most straightforward ways are to: 1) perform a functional communication-test to each peripheral and record the results; 2) use a signal-strength meter at the peripheral positions and communication infrastructure positions, to record the signal-strength levels.

The disadvantage with the first method is that it just gives the answer “GO/NO GO”, where “GO” means that communication was established and “NO GO” means that no communication was established. No information about the signal-strength margin is obtained. A signal-strength margin is needed in order to be able to handle signal-strength variations due to rearrangements of, and ageing of, components, etc. This means, for example, that a system that shows 100% communication at a specific time, for example, at the customer acceptance test for such a system, may, after a rearrangement or manipulation of the installation environment, fail to communicate with some peripherals.

The disadvantages with the second method are that this method is very time-consuming, and that it does take into consideration the different variations (e.g. due to component variations and manufacturing tolerances) in performance of the units in the communication infrastructure and the peripherals.

In systems for electronic shelf labelling, a few transceiver units (TX) connected in the wireless communication infrastructure communicate with perhaps more than 10 000 label units.

### SUMMARY OF THE INVENTION

Therefore the invention is based on the insight that the most cost-efficient way of designing such systems is to keep the peripherals as simple as possible, and to solve any technical problems in the (TRX) instead. In devices and systems in accordance with the present invention, power-levels and detection-levels can be manipulated in the TRX, in order to be able to produce a simple peripheral unit. However, there are a few different additional possibilities for realising the objective of the invention, namely by adjusting other parameters, such as, the detection-level in the peripheral and/or the output power of the peripheral. A method of measuring the signal-strength and reporting this back to the communication infrastructure system, and then calculating the power margin there is, also within the scope of the present invention. By the expression “signal power margin” we mean the ratio between the actual signal power and the minimum signal power that is required to be able to transmit the signal from the transmitter part to the receiver part of a communication link. The signal power margin is normally expressed in percentage of the minimum required signal.

For example if the minimum required signal is 100 and the actual signal is 120 the power margin is [120/100=1,2] i.e. 20%.

The present invention therefore comprises measuring the power margin (i.e. the robustness) in wireless systems, by the manipulation of signal-levels and detection levels, and in this way emulating a real-life situation with ageing of components and rearranging/relocating peripherals/communication infrastructure units etc., in such a system.

The inventive features of the method according to the present invention are set forth in claim 1. The inventive method of testing signal power margin in a wireless local area network comprising transceivers and peripherals, comprises setting transmission and/or receiving parameters (herein collectively referred to as “transmission power parameters”) in at least one transceiver unit in said local area network such that a situation is simulated that corresponds to a system where the power margin is reduced; sending a message to said peripheral from said transceiver; and registering whether or not an acknowledgement from said peripheral is received by the transceiver unit.

In a further aspect of the present invention there is provided a system for ensuring adequate robustness in a wireless system after the installation of such a system, which system does not suffer from the problems associated with prior art systems. A system according to the invention is defined in claim 11.

### BRIEF DESCRIPTION OF THE DRAWINGS

The present invention, both as to its organisation and way of operation, together with further objects and advantages, may best be understood by reference to the following non-limiting descriptions of embodiments of the present invention, taken in connection with the accompanying drawings, of which:

FIG. 1 is a schematic view of a wireless communication system, with communication infrastructure units, and wireless communicating peripherals, having a power margin test system in accordance with the present invention.

FIG. 2 is a schematic illustration an embodiment of a power margin test system in accordance with the present invention;

FIG. 3 is a schematic illustration of a further embodiment;

FIG. 4 illustrates an InfraStructure Test Tool (ISTT); and

### DETAILED DESCRIPTION OF PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein especially to provide methods for testing power margins and ensuring suitable power margins in any system incorporating wireless communication.

As used herein the expression “transmission power parameter” shall mean any parameter in the system that can be used to control the level of power in transmitted signals, the signal detection threshold level in a receiver, the signal power level in acknowledgment messages from peripherals, or any other parameter that can be used to adjust the relative levels of transmitted and received signal power (or strength) in the system units.

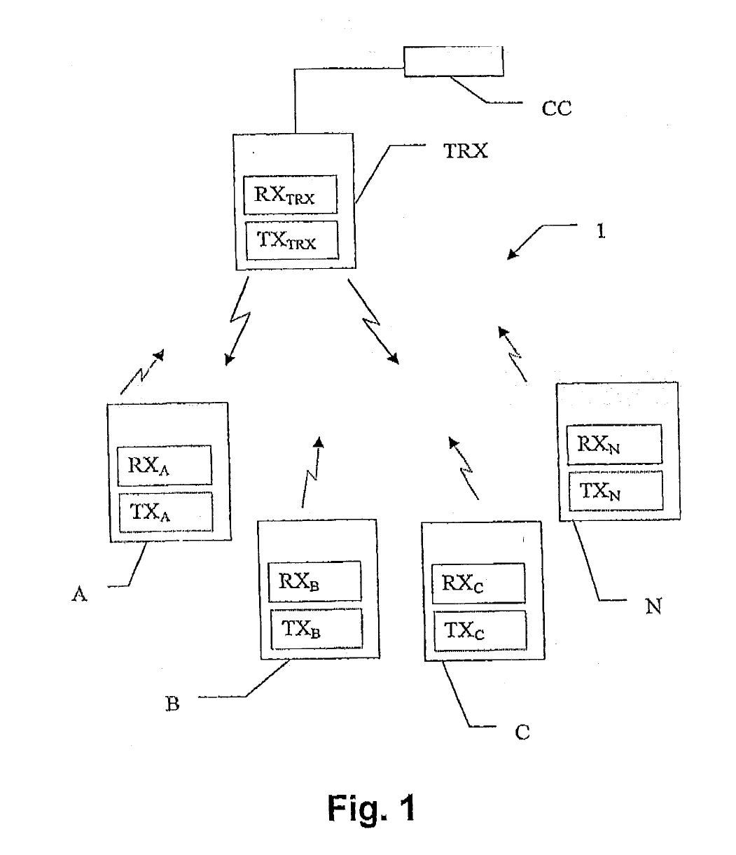

The present invention can best be understood by first considering FIG. 1, and the related sequence description. TRX is a part of a wireless communication infrastructure 1 and is able to receive and transmit wireless data (shown by zigzag arrows). It is controlled by a communication controller CC. TRX could use infrared signals and/or radio frequency signals or other techniques for the physical link in the wireless communication system. The signal-power P for the transmitting part TX_{TRX} and/or the receiver sensitivity D (detection level) in the receiver part RX_{TRX} can be adjusted. A, B, C, . . . , N are peripherals in the wireless communication infrastructure which TRX is intended to communicate with. These peripherals could be, for example, some or all of the electronic shelf labels, ESL's A-N in shop. Peripherals A-N, each have at least a receiver unit RXₙ, but preferably also a transmitting unit TXₙ (shown in dotted lines).

When performing the power margin-test, first a reference transmission by TRX is made, with a nominal setting of transmission power (Pₙₒₘᵢₙₐₗ) and a nominal setting of detection threshold level (Dₙₒₘᵢₙₐₗ). Then a transmission is made to each of the peripherals A, B, C, . . . N in turn and any replies received from the peripherals A, B. C, . . . N are recorded. If a reply is received from every peripheral, then the transmission power is sufficient to reach every peripheral A, B, C, . . . N but the signal-strength power margin in the wireless communication infrastructure 1 is unknown. In the next step, the power-level is reduced to a predefined value (P_{reduced}) corresponding to the desired power margin in the system. The transmissions to all of the peripherals A-N are repeated, but now with this lower power level P_{reduced} and the results of the answers from the peripherals for this transmission are recorded. If all the addressed peripherals replied then the power margin in the down-link is greater than or equal to the ratio P nominal/P reduced.

If one or more addressed peripheral did not reply then the power margin is less then the P nominal/P reduced. The system will create a list of those peripherals that failed, and these can then be replaced by new ones.

The method described above constitutes a power margin test for the down-link, but could equally well be conducted on the up-link, by following the steps of;

1) make reference transmissions from all the peripherals in turn, with the TRX detection level set to Dₙₒₘᵢₙₐₗ;

2) if all the reference transmissions are detected by TRX then increase the detection level in TRX by a predefined value to D_{increased} which corresponds to the power margin that is wanted in the system.

Sequence Description

1. Power Margin Reference Test;

First the transmitterpower is set to Pₙₒₘᵢₙₐₗ. Then the system transmits a test message to peripheral A. If the message is correctly received, A sends back an acknowledgement (ACK). If there is no ACK within a set period of time, a no acknowledgement (NOACK) is recorded for this peripheral. Alternatively, a new test message is sent, and an ACK is waited for. This procedure could be repeated a desired number of times. When ACK has been verified or a NOACK has been recorded, the system goes on to perform the same procedure for all installed peripherals.

This process can be schematically illustrated with the sequence of steps below, which represents a successful testing with b 100% functionality, i.e. the system function is verified in the nominal transmission power mode.

1. Set transmitter power [symbol] Pₙₒₘᵢₙₐₗ

2. TRX [symbol] > A

3. A [symbol] TRX; ACK received

4. TRX [symbol] B

5. B [symbol] TRX; ACK received

6. TRX [symbol] C

7. C=TRX; ACK received

8. And so on . . . until, and including N

Thus, this sequence gives information about functional units where the system is able to make a wireless connection. When the actual power margin test is performed, a new transmitter power should be set.

As an example, if one should like to have 3 dB power margin, the output power in the power margin test should be reduced by 50%.

2. Power Margin Test

The same procedure as above is run but with the power reduced so as to simulate a situation where the peripherals are not 100% functional (relative the nominal).

1. Set transmitter power=/P_{reduced}

2. TRX [symbol] A

3. A [symbol] TRX; ACK received

4. TRX [symbol] B

5. B [symbol] TRX; ACK received

6. TRX [symbol] C

7. C [symbol] TRX; ACK received

8. And so on . . . until and including N

If the results from the second transmission are identical with the results from the first transmission, the power margin in this case is>Pₙₒₘᵢₙₐₗ/P_{reduced}. Thus, in this case the transmission power parameter that is manipulated is the transmitter power.

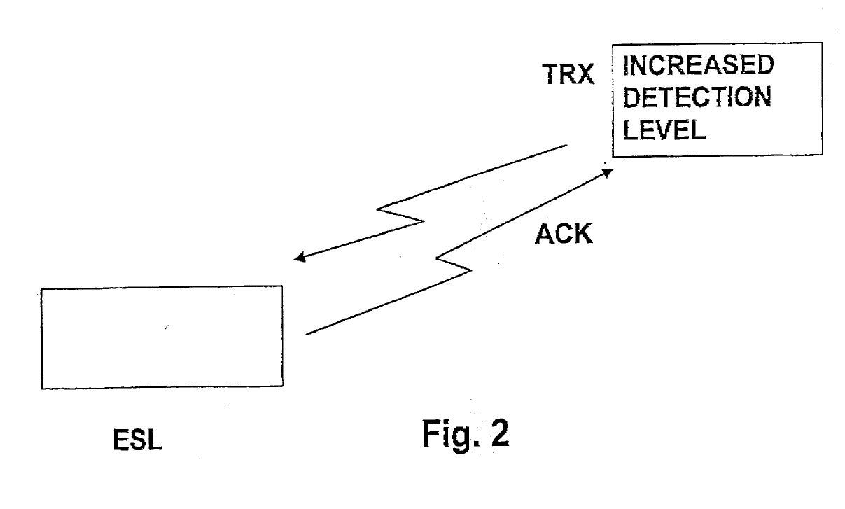

The above procedure is based on manipulation of the down link power. However, it is equally possible to use the up link for the test. In a first embodiment of this variant, schematically illustrated in FIG. 2, the detection threshold for the ACK signal in the TRX is increased, thereby simulating a weaker transmitted ACK signal. This can be illustrated with the following sequence:

1. Set detection threshold in TRX=T_{increased}

2. TRX [symbol] A

3. A [symbol] TRX; ACK detected

4. TRX [symbol] B

5. B [symbol] TRX; ACK detected

6. TRX [symbol] C

7. C=TRX; ACK detected

8. And so on . . . until and including N

Thus, in this case the transmission power parameter is the detection Threshold for the ACK signal.

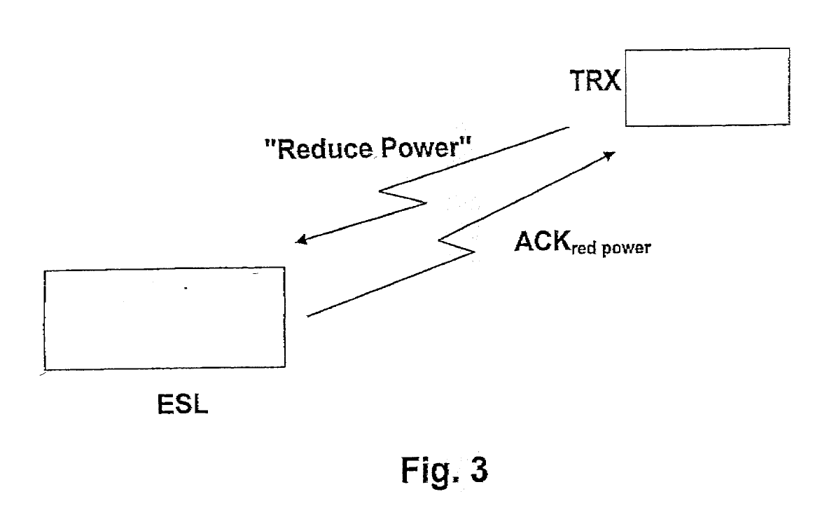

In an another embodiment, schematically illustrated in FIG. 3, the ESL, will contain more “intelligence”. Namely, there will be means for reducing the power of the ACK signal to be transmitted to the TRX, in response to a REDUCE POWER message from the TRX. In this way, a factual reduction of the performance of the ESL can be simulated. Of course there will be means for resetting the power to nominal after the test has been performed. This could be done by a further RESET POWER message from the TRX, or simply a reset after a predetermined time delay. In this case the transmission power parameter is the signal power in the acknowledgement signal.

In a further embodiment of the invention there is provided an infrastructure test tool (ISTT). This is a tool for testing of infrastructure installations comprising a number of units (such as ESL's) communicating with a base station.

The main purpose with ISTT is to communicate with all units in the infrastructure and to verify the communication link performance of an installation.

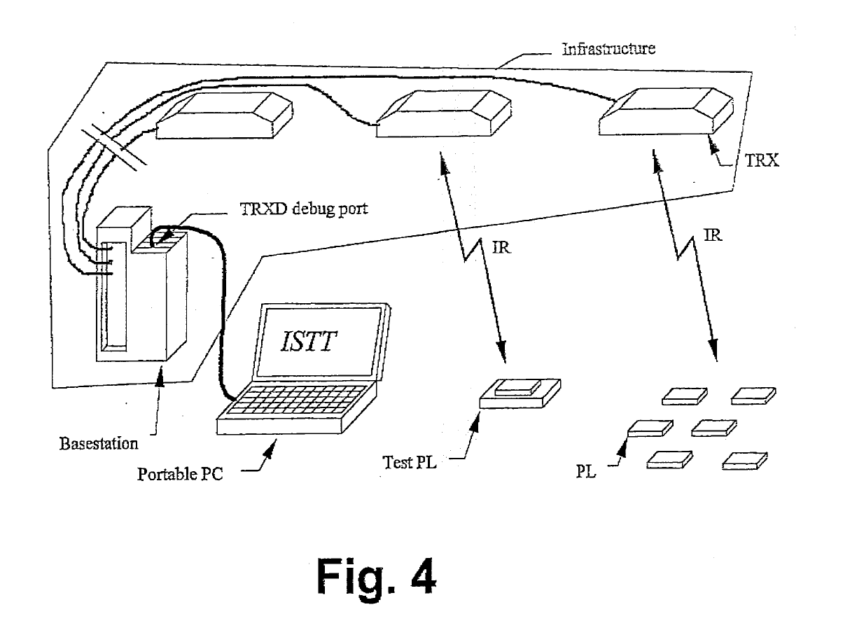

The test tool can be connected to the infrastructure in a number of possible ways. One example is shown in FIG. 4.

Communication Link Test Function

Communication link test is a test method to investigate the coverage of the down and up link in a store environment. The test tool sends a frame to a specific test PL which will send an acknowledgement (ACK) pulse. ACK or no ACK is detected by all Transceivers (TMX's). The test tool evaluates the ACK information and sends a new frame down to the test PL. All frames sent to the test PL updates the display with the following information:

1. A counter that shows how many ACKs that was received.

2. A symbol that toggles between two states. Toggles for each frame that was sent.

3. Which Transceiver (TRX) that receives the strongest ACK.

4. How many TRX'es that are receiving ACK.

The ACK counter (item 1.) counts from 0 to 99 and starts over on 0 again. The counter shows if there exists a valid up link signal (ACK). The counter stops to count on the test PL when the up link gets below the minimum requirements for the TRX.

The Down link toggler (item 2.) is toggling as long as the PL receives frames. When downlink gets below the minimum requirements for tie PL, the toggling stops.

Item 3. shows which TRX that received the strongest ACK when last frame was sent. If more than one TRX have the same strength, the TRX with the highest number will be displayed. Item 4. shows how many TRX that received an ACK for last frame, This value is used for detecting whether the coverage is “too good” (i.e. to small TRX grid).

There is an option ‘Set Down Link Level’ and an option ‘Set Up Link Level’. With these options the TRX down link output and up link sensitivity can be reduced, i. e. making a poorer link when running the Communication link Test.

There is an option ‘Find Link Margins’. When using this function the PL shall be in a fixed position and ISTT searches for the lowest down link output and lowest up link sensitivity in TRX with link established to the PL. When these levels are found the result is presented as link level settings on the PC monitor. (The function ‘Find Link Margins’ do not use the display of the PL.)

The Communication link test can record data to a file during the test. The test tool creates a log file. When data is collected to the log file, the test tool has to ask the recording TRX for the ACK levels after each transmitted frame.

Although the invention has been described with reference to an electronic shelf labelling system, it should be apparent to the skilled man that it can be implemented for any wireless communication system, where it is important that the signal-strength power margin be controlled.

1. A method of testing signal power margin in a wireless local area network (LAN) for at least one transceiver unit (TRX), and at least one peripheral unit (ESL) in said local area network (LAN), wherein each at least one peripheral unit is capable of responding to a message from said transceiver unit (TRX) by sending an acknowledgement signal (ACK) back to said transceiver unit (TRX), and wherein the system function at nominal signal power has been verified, the method comprising:
simulating a situation in the network where the acknowledgement signal (ACK) power is reduced, by manipulating a transmission power parameter in the system;
sending a message to said peripheral (ESL) from said transceiver (TRX); and
registering whether or not an acknowledgement (ACK) from said peripheral (ESL) is received by the transceiver unit (TRX); wherein
the local area network (LAN) is an electronic shelf labeling system for retail environments, and wherein the peripheral units are electronic shelf labels (ESL).

2. The method as claimed in claim 1, wherein the simulation is performed by manipulating the transmission power and/or the signal detection threshold in the transceiver unit(s) (TRX), and/or in the peripheral(s) (ESL).

3. The method as claimed in claim 1, wherein the transmission power in the transceiver (TRX) is set such that the message is sent at lower power than nominal.

4. The method as claimed in claim 1, wherein the detection threshold level in said transceiver unit (TRX) is increased.

5. The method as claimed in claim 1, wherein the message contains an instruction to the peripheral unit (ESL) to reduce its signal power for the acknowledgement (ACK).

6. The method as claimed in claim 5, wherein the signal power for acknowledgment (ACK) is reset.

7. The method as claimed in claim 6, wherein said resetting is made by sending a RESET POWER instruction from the transceiver (TRX) to the peripheral (ESL).

8. The method as claimed in claim 6, wherein said resetting is made automatically after a predetermined time delay.

9. The method as claimed in claim 1, comprising increasing the detection threshold of the transceiver (TRX) for detecting an acknowledgement signal (ACK) from the peripheral (ESL).

10. A signal power margin test system for a local area network (LAN), comprising at least one transceiver unit (TRX) and at least one peripheral unit (ESL), wherein each at least one peripheral unit is capable of responding to a message from said transceiver unit (TRX) by sending an acknowledgement signal (ACK) back to said transceiver unit (TRX), the test system comprising
a control unit programmable to switch the relative signal power levels between a nominal power situation, and a simulated situation that corresponds to a system where the power margin is reduced; and
a recording unit (CC) capable of registering whether or not an acknowledgement (ACK) from said peripheral (ESL) is received by the transceiver unit (TRX);
wherein the local area network (LAN) is an electronic shelf labelling system for retail environments, and wherein the peripheral units are electronic shelf labels (ESL).

11. The system as claimed in claim 11, wherein each peripheral unit (ESL) has a unique identifier associated therewith.

12. The system as claimed in claim 11, comprising an error list generator for the presentation of peripheral units that failed in the power margin test.
